(19) United States
(12) Patent Application Publication
(10) Pub. No.: US 2023/0351880 A1
(43) Pub. Date: Nov. 2, 2023

(54) LIQUID LEVEL SENSOR AND PROTECTIVE COVER

(71) Applicant: Frank Gerlach, Mississauga (CA)

(72) Inventor: Frank Gerlach, Mississauga (CA)

(21) Appl. No.: 18/115,200

(22) Filed: Feb. 28, 2023

Related U.S. Application Data
(60) Provisional application No. 63/315,161, filed on Mar. 1, 2022.

(51) Int. Cl. G08B 21/20; G01F 23/24

(52) U.S. Cl. CPC G08B 21/20; G01F 23/242

(57) ABSTRACT

A liquid level sensor comprises a main body, a common electrical contact, a base-level electrical contact, and a first-raised-level electrical contact. The common electrical contact and the base-level electrical contact together define a base liquid sensing level. The common electrical contact and the first-raised-level electrical contact together define a first raised liquid sensing level. Electronic circuitry is responsive to a path between the common electrical contact and the base-level electrical contact being electrically closed by moisture to generate a base-level alarm signal, and responsive to a path between the common electrical contact and the first-raised-level electrical contact being electrically closed by moisture to generate a second-level alarm signal. Alternatively, a first pair of electrical contacts and a second pair of electrical contacts may be used.

### FIELD OF THE INVENTION

The present invention relates to liquid level sensors and more particularly to liquid level sensors for sensing a plurality of liquid levels, and also to protective covers therefor.

### BACKGROUND OF THE INVENTION

Most prior art liquid level sensors operate by sensing low level current flow between two (2) electrical contacts when both electrical contacts are in contact with a common body of liquid, as shown in FIGS. 1A and 1B. The liquid, even if it is just moisture, closes a path between the two electrical contacts. Electronic circuitry responsive to the path between the two electrical contacts being electrically closed by the liquid, senses the closure of the circuit and accordingly can generate an alarm signal. The electronic circuitry is either triggered or not triggered to thereby provide an alarm. This is a well-known art and not elaborated further.

In use, with the liquid level sensor in place typically on or near a surface, when a leak is detected, audible and/or visible alarms may be generated by the device, and alarm information and/or control messages may be transmitted via wired or wireless communication means to control panels, wireless devices, and so on, and may be used to shut off liquid supply lines, among other remedial activities.

A problem with this singular response approach, or in other words sensing only one liquid level, is that the system reacts to small amounts of moisture on a floor and larger floods, possibly from a serious leak, in exactly the same way. Condensation may even trigger an alarm when no leak is present. Conventional liquid leak sensors are depicted in FIG. 1A and FIG. 1B.

Various prior art conventional liquid level sensors are known, and include the following devices.

One such prior art device for sensing a water level can be found in U.S. Pat. No. 9,432,763 issued Aug. 30, 2016, to Scharf, and entitled Water Leak Warning Device. A water leak warning device is described and taught having a hollow body having an interior space and an outer surface, the hollow body having walls comprising a bottom wall and a side wall, the bottom wall having a bottom flat surface; at least two electrodes each extending out of the bottom flat surface in a direction generally perpendicular to the bottom flat surface; a power supply enclosed in the interior space of the hollow body; and a speaker enclosed in the interior space of the hollow body; wherein the at least two electrodes, the power supply, and the speaker are operatively connected by conducting elements such that when the at least two electrodes are connected by a conductive material, an audible signal is emitted by the speaker.

The water leak warning device may also have a plurality of protruding elements having substantially equal height, being rooted on the lower end of the side wall and extending from the side wall in a direction generally perpendicular to the bottom flat surface, with gaps between the protruding elements. The protruding elements may also be rooted directly from the bottom surface. Such designs may allow any water that leaks onto the ground to flow through the gaps between the protruding elements and reach under the bottom flat surface of the water leak warning device.

The water leak warning device may further have two or more electrodes each having a first end and a second end, the first ends of the electrodes protruding out of the flat surface of the hollow body in a direction generally perpendicular to the flat surface, the length of the first ends extending out of the hollow body may be shorter than, equal to, or slightly longer than, the length of the protruding elements extending out of the peripheral edge of the bottom flat surface, the second ends of the electrodes being enclosed in the interior space of the hollow body. When the user puts the water leak warning device on the ground, the first ends of the electrodes may or may not have constant contact with the ground because the part of the electrodes extending out of the bottom flat surface may be slightly longer than, equal to, or shorter than, the length of the protruding elements extending out of the peripheral edge of the bottom flat surface. The gaps between the protruding elements ensure that leaked water can flow through to make contact with the first ends of the electrodes.

The water leak warning device further has a power supply, a speaker, and an amplifier, all of which are enclosed in the interior space of the hollow body. The electrodes, the power supply, the speaker and the amplifier are operatively connected by conducting elements such that when the first ends of the electrodes are connected by conductive material, such as water, an audible signal is emitted by the speaker. When leaked water reaches the spot where the warning device is placed, the first ends of the electrodes are connected through the water, thereby triggering an alarm. The user of the device can thus be warned and take actions to prevent further leakage and mitigate any damage.

In another embodiment there is a water leak warning device having a rectangular hollow body having an interior space, the hollow body having rigid walls comprising at least a top wall, a bottom wall, and a plurality of side walls, wherein there is an adhesive disposed on at least one of the plurality of side walls; at least two electrodes each having a first end extending out of the bottom wall in a direction generally perpendicular to the bottom wall; a power supply enclosed in the interior space of the hollow body; a speaker enclosed in the interior space of the hollow body; an aperture traversing at least one of the plurality of the side walls, wherein the at least two electrodes, the power supply, and the speaker are operatively connected by conducting elements such that when the first end of each of the at least two electrodes are connected by a conductive material, an audible signal is emitted by the speaker through the aperture traversing the at least one side wall; and a reverberating chamber partially or wholly surrounding the aperture.

Another relevant prior art patent is U.S. Pat. No. 10,480,824, issued Nov. 19, 2019, to Gardner et al., and entitled Leak Detection Sensor Assemblies For Water Heaters. The leak detection system includes a leak sensor assembly that is disposed in a bottom pan of the water heater. The leak sensor assembly includes a sensor housing that has a sensor channel that is formed therein such that the sensor channel is disposed at an elevation from a base of the bottom pan when the sensor housing is disposed on the base of the bottom pan. Further, the leak sensor assembly includes a leak sensor that is disposed in the sensor channel of the sensor housing. The leak sensor detects water that leaks from the water heater and accumulates in the bottom pan when a level of the water in the bottom pan rises to the elevation of the sensor channel and the leak sensor that is disposed therein.

Another relevant prior art patent is U.S. Pat. No. 11,047,761, issued Jun. 29, 2021, to Frackelton et al., and entitled Integrated Leak Detection. Exemplary systems of the invention comprise a leak detection module with a processor that processes signals from a plurality of low-cost sensors installed multiple locations throughout a fluid system, e.g., throughout a house, to determine the presence of a leak in the fluid system. An exemplary electronic plumbing fixture fitting comprises a fixture body including a discharge outlet, the discharge outlet being operable to deliver water via a fluid path; an electronically controlled valve in fluid communication with the fixture body in the fluid path upstream of the discharge outlet; at least one processor programmed to control the electronically controlled valve to selectively control a flow of fluid from the electronically controlled valve out the discharge outlet of the fixture body; and a local water sensor in electrical or optical communication with the processor, operably connected to the fixture body, and positioned to generate a local leak sensing signal having local sensed leak data imposed thereon, the local sensed leak data indicating a leak in the fluid path; and wherein the at least one processor has code causing the at least one processor to determine the presence of leaks in the fluid path using at least the local sensed leak data; and wherein the at least one processor has code causing the at least one processor to, in response to determining the presence of a leak in the fluid path using at least the local sensed leak data, perform any one of or both of the following: transmit to another processor, using communications circuitry, data indicating the presence of the detected leak in the fluid path; and automatically adjust the electronically controlled valve to adjust the flow of water flowing through the electronically controlled valve.

Another relevant prior art patent is U.S. Pat. No. 11,378,538, issued Jul. 5, 2022, to Lee et al., and published as United States Published Patent Application No. US20200264120A1, and entitled Water Detector. A water detection device includes a pair of electrical connectors that are coupled to electrical contacts that may be mechanically biased. A water sensor circuit is configured to detect water by delivering a signal to an electrical contact. The presence of water may be determined based upon detection of the signal at the other contact. The water sensor circuit device may be configured with a comparator that uses hysteresis to provide sensitivity to the presence or absence of water. In a battery-powered water sensor, the water detection signal may be delivered as an alternating signal using, e.g., a signal modulator circuit (e.g., an oscillator circuit and gate optionally coupled to a wake-sleep controller that is coupled to a battery, which may avoid oxidation or other forms of ionic corrosion. In some examples, a water detection signal may be recurrently delivered to the first contact to conserve battery power.

It is an object of the present invention to provide a liquid level sensor for sensing at least a base liquid sensing level and generating a base-level alarm signal, and sensing a first raised liquid sensing level and generating a first-level alarm signal.

It is an object of the present invention to provide a liquid level sensor that eliminates false alarms.

It is an object of the present invention to provide a liquid level sensor that identifies the presence of moisture on a surface.

It is an object of the present invention to provide a liquid level sensor that identifies various water levels.

It is an object of the present invention to provide a liquid level sensor that identifies various water levels, such as a drip (perhaps 2 mm of water), a leak (perhaps 4 mm of water), or a flood (perhaps 6 mm of water).

It is an object of the present invention to provide a liquid level sensor that allows a user to make decisions with confidence regarding water levels.

It is an object of the present invention to provide a liquid level sensor, wherein the sensor is protected from the environment.

It is an object of the present invention to provide a liquid level sensor, wherein the sensor is protected from external forces.

It is an object of the present invention to provide a liquid level sensor, wherein the sensor is protected from external impacts.

It is an object of the present invention to provide a liquid level sensor, wherein the sensor is precluded from being readily moved once installed.

It is an object of the present invention to provide a liquid level sensor, wherein the sensor is precluded from being readily moved once installed, and therefore is pet-safe and child-safe.

It is an object of the present invention to provide a liquid level sensor, wherein the senor has several installation options.

It is an object of the present invention to provide a combination of a liquid level sensor and a protective cover for sensing at least a base liquid sensing level and generating a base-level alarm signal, and sensing a first raised liquid sensing level and generating a first-level alarm signal.

It is an object of the present invention to provide a combination of a liquid level sensor and a protective cover that eliminates false alarms.

It is an object of the present invention to provide a combination of a liquid level sensor and a protective cover that identifies the presence of moisture on a surface.

It is an object of the present invention to provide a combination of a liquid level sensor and a protective cover that identifies various water levels.

It is an object of the present invention to provide a combination of a liquid level sensor and a protective cover that identifies various water levels, such as a drip (perhaps 2 mm of water), a leak (perhaps 4 mm of water), or a flood (perhaps 6 mm of water).

It is an object of the present invention to provide a combination of a liquid level sensor and a protective cover that allows a user to make decisions with confidence regarding water levels.

It is an object of the present invention to provide a combination of a liquid level sensor and a protective cover, wherein the sensor is protected from the environment.

It is an object of the present invention to provide a combination of a liquid level sensor and a protective cover, wherein the sensor is protected from external forces by the protective cover.

It is an object of the present invention to provide a combination of a liquid level sensor and a protective cover, wherein the sensor is protected from external impacts by the protective cover.

It is an object of the present invention to provide a combination of a liquid level sensor and a protective cover, wherein the sensor and protective cover are precluded from being readily moved once installed.

It is an object of the present invention to provide a combination of a liquid level sensor and a protective cover, wherein the sensor and protective cover are precluded from being readily moved once installed, and therefore is pet-safe and child-safe.

It is an object of the present invention to provide a combination of a liquid level sensor and a protective cover, wherein the senor and protective cover have several installation options.

### SUMMARY OF THE INVENTION

In accordance with one aspect of the present invention there is disclosed a novel liquid level sensor comprising a main body, a common electrical contact, and a base-level electrical contact. The common electrical contact and the base-level electrical contact together define a base liquid sensing level. The liquid level sensor also comprises a first-raised-level electrical contact. The common electrical contact and the first-raised-level electrical contact together define a first raised liquid sensing level. Electronic circuitry is responsive to a path between the common electrical contact and the base-level electrical contact being electrically closed by moisture and to generate a base-level alarm signal, and responsive to a path between the common electrical contact and the first-raised-level electrical contact being electrically closed by moisture and to generate a second-level alarm signal. In use, when moisture closes a path between the common electrical contact and the base-level electrical contact, the base-level alarm signal is generated to thereby indicate the base liquid sensing level, and when moisture closes a path between the common electrical contact and the first-raised-level electrical contact, the second-level alarm signal is generated.

In accordance with one aspect of the present invention there is disclosed a novel liquid level sensor comprising a main body and a first pair of electrical contacts. The first pair of electrical contacts defines a base liquid sensing level. The liquid level sensor also comprises a second pair of electrical contacts. The second pair of electrical contacts defines a first raised liquid sensing level. Electronic circuitry responsive to a path between the first pair of electrical contacts being electrically closed by moisture and to generate a base-level alarm signal, and responsive to a path between the second pair of electrical contacts being electrically closed by moisture and to generate a second-level alarm signal. In use, when moisture closes a path between the first pair of electrical contacts, the base-level alarm signal is generated to thereby indicate the base liquid sensing level, and when moisture closes a path between the second pair of electrical contacts, the second-level alarm signal is generated.

In accordance with one aspect of the present invention there is disclosed a novel protective cover for use with a liquid level sensor. The protective cover comprises a main shell body extending between a first end and a second end, between a first side and a second side, and between and top portion and a bottom edge. The main shell body defines an open cavity defined by a bottom edge and open to the bottom of the main shell body. There is a ground contact portion disposed at the bottom of the main shell body to define a ground contact plane.

In accordance with one aspect of the present invention there is disclosed a novel combination of a liquid level sensor and a protective cover comprising a liquid level sensor having a main body and a liquid level sensing mechanism, and defining a ground contact plane; and a main shell body extending between a first end and a second end, between a first side and a second side, and between and top portion and a bottom edge, and defining an open cavity extending upwardly from a bottom edge and open to the bottom of the main shell body, and a ground contact portion disposed at the bottom of the main shell body to define a ground contact plane. In use, the liquid level sensor rests on a receiving surface at the ground contact plane and the main shell body rests on the receiving surface at the ground contact plane.

In accordance with one aspect of the present invention there is disclosed a novel combination of a liquid level sensor and a protective cover comprising a liquid level sensor having a main body with an upper body portion and a liquid level sensing mechanism; and a main shell body. The upper body portion of the liquid level sensor and the main shell body are similar in shape each to the other.

In accordance with one aspect of the present invention there is disclosed a novel combination of a liquid level sensor and a protective cover comprising a liquid level sensor having a main body with an upper body portion and a liquid level sensing mechanism; and a main shell body having a sensor-receiving cavity.

In accordance with one aspect of the present invention there is disclosed a novel combination of a liquid level sensor and a protective cover comprising a liquid level sensor having a main body, a ground contact portion, and a liquid level sensing mechanism; and a main shell body having a ground contact portion. In use, the ground contact portion of the main shell body peripherally surrounds the ground contact portion of the liquid level sensor.

In accordance with one aspect of the present invention there is disclosed a novel combination of a liquid level sensor and a protective cover comprising a liquid level sensor having a main body, a ground contact portion, and a liquid level sensing mechanism; and a main shell body having a ground contact portion. The ground contact portion of the main shell body defines a larger ground contact area than the contact portion of the liquid level sensor.

In accordance with one aspect of the present invention there is disclosed a novel combination of a liquid level sensor and a protective cover comprising a liquid level sensor having a main body, a ground contact portion, and a liquid level sensing mechanism; and a main shell body having a ground contact portion. In use, the main shell body is disposed in overlying relation to the liquid level sensor.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a first illustrated embodiment of the invention will now be illustrated by way of example. It is expressly understood, however, that the drawings are for the purpose of illustration and description only, and are not intended as a definition of the limits of the invention. In the accompanying drawings:

FIG. 1 is diagrammatic view of the overall liquid level sensor system;

FIG. 2 is a perspective view from the side of the first illustrated embodiment of the liquid level sensor according to the present invention;

FIG. 3 is a top plan view of the first illustrated embodiment of the liquid level sensor of FIG. 2;

FIG. 4 is a perspective view from the side of the second illustrated embodiment of the liquid level sensor according to the present invention;

FIG. 5 is top plan view of the third illustrated embodiment of the liquid level sensor according to the present invention;

FIG. 6 is a bottom plan view of the third illustrated embodiment of the liquid level sensor of FIG. 5;

FIG. 7 is a side elevational view of the third illustrated embodiment of the liquid level sensor of FIG. 5;

FIG. 8 is a rear elevational view of the third illustrated embodiment of the liquid level sensor of FIG. 5;

FIG. 9 is a front elevational view of the third illustrated embodiment of the liquid level sensor of FIG. 5;

FIG. 10 is side elevational view of the fourth illustrated embodiment of the liquid level sensor according to the present invention;

FIG. 11 is top plan view of the illustrated embodiment of the protective cover according to the present invention;

FIG. 12 is perspective view of the illustrated embodiment of the protective cover according to the present invention shown in FIG. 11;

of the present invention that comprises a combination of a liquid level sensor and a protective cover;

FIG. 13 is top plan view of the illustrated embodiment of the liquid level sensor and a protective cover according to the present invention; and,

FIG. 14 is a partially cut-away perspective view of the illustrated embodiment of the liquid level sensor and a protective cover according to the present invention as shown in FIG. 13.

### LIST OF COMPONENTS AND REFERENCE NUMERALS

100 liquid level sensor
102 overall liquid level sensor system
120 main body
121 first end
122 second end
123 top
124 bottom
125 first side
126 second side
127 ground contact portion
128 foot portion
129 downwardly sloped portion
130 “U”-shaped grasping handle
132 securing clip
140b base-level electrical contact
140c common electrical contact
141 first-raised-level electrical contact
141c,141b outer ends
142 second-raised-level electrical contact
143 third-raised-level electrical contact
150 electronic circuitry
152 battery
154 antenna
BL base liquid sensing level
GCPL ground contact plane
L line
1SL first raised liquid sensing level
2SL second raised liquid sensing level
1OD first offset distance
2OD second offset distance
3OD third offset distance
4OD fourth offset distance
200 liquid level sensor
220 main body
222 second end
224 bottom
228 foot portion
229 downwardly sloped portion
240b base-level electrical contact
240c common electrical contact
241 first-raised-level electrical contact
242 second-raised-level electrical contact
A arrows
300 liquid level sensor
320 main body
340b base-level electrical contact
340c common electrical contact
400 liquid level sensor
420 main body
427 ground contact portion
441 first pair of electrical contacts
442 second pair of electrical contacts
443 third pair of electrical contacts
500 protective cover
502 liquid level sensor
503 grasping handle
504 receiving surface
520 thin curved main shell body
521 first end
522 second end
523 first side
524 second side
525 top portion
526 bottom edge
528 space
540 open cavity
550 ground contact portion
550a,550b,550c,550d plurality of feet comprises four feet
600 combination liquid level sensor and protective cover
601 protective cover
604 receiving surface
610 liquid level sensor
611 upper body portion
612 main body
613 contact portion
620 electrical contacts
640 main shell body
641 first end
642 second hand
643 first side
644 second side
645 top portion
646 bottom edge
648 open cavity
649 space
650 ground contact portion
1SL first raised liquid sensing level
BL base liquid sensing level
GCPL ground contact plane
650a,650b,650c,650d plurality of feet comprises four feet

### DETAILED DESCRIPTION OF THE ILLUSTRATED EMBODIMENTS

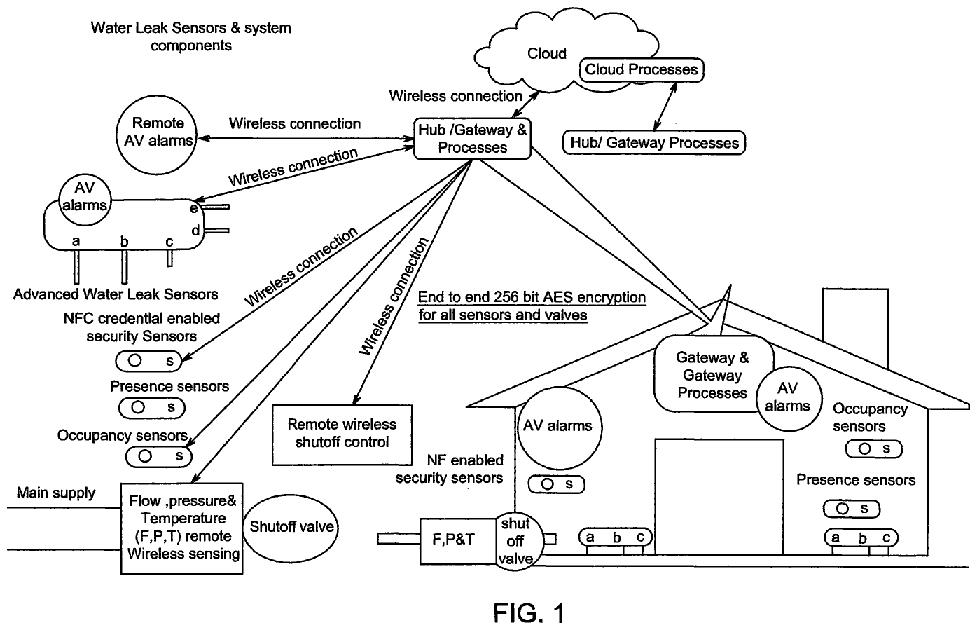

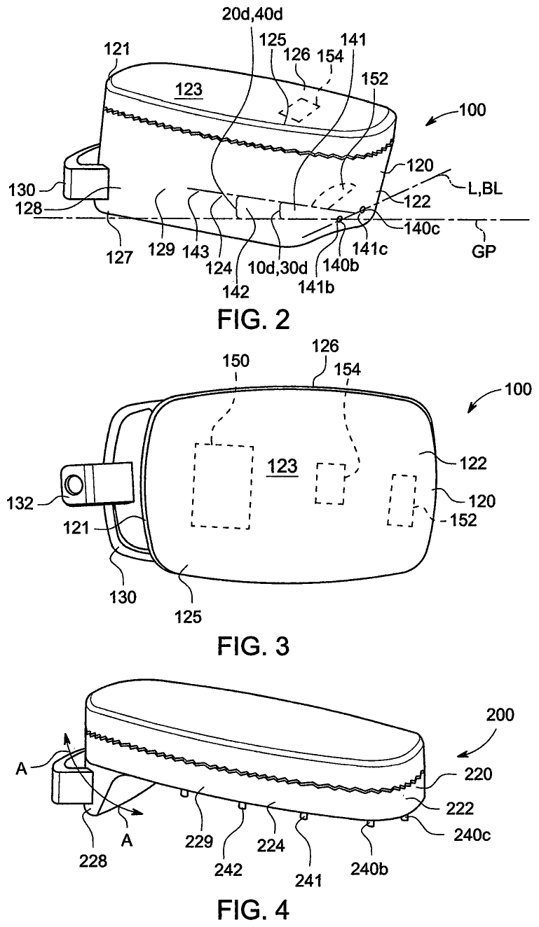

Reference will now be made to FIGS. 1 through 12, which show the illustrated embodiments of the liquid level sensor and protective cover according to the present invention, and the overall liquid level sensor system.

Reference will now be made to FIGS. 1 through 3, which illustrate a first embodiment of the liquid level sensor according to the present invention, as indicated by the general reference numeral 100 and the overall liquid level sensor system as indicated by the general reference numeral 102.

Reference will now be made to FIG. 1, which shows one possible embodiment of the overall liquid level sensor system 102, according to the present invention. The overall liquid level sensor system 102 may generate various types of alarm signals in response to detecting liquid, which may be known as a “liquid sensing event”.

The response to an alarm signal from the overall liquid level sensor system 102 is definable, selectable, and/or customizable by a user, based on severity of a liquid sensing event. In the present system, four (4) graduated “liquid sensing event” (which may also be considered as “liquid levels”) may be defined and monitored. These four (4) graduated liquid sensing events may include, but are not limited to, moisture, leak, flood and catastrophe. Leak detection can further be qualified by pressure, temperature, and flow characteristics.

The overall liquid level sensor system 102 would monitor water temperature, pressure and flow, possibly as follows.
Pressure—when there is a leak, the line water pressure would drop slightly, especially if a major pipe burst or the like. The overall liquid level sensor system 102 monitors the line water pressure, and can correlate pressure drop with known water pressure values that might occur in a flood. Some toilet leak sensors use pressure differential to determine if there is sustained pressure drop, indicative of a slow leak.
Temperature—line water temperature could change quickly with high flow.
Water flow—a sustained leak would result in a sustained flow and if both are present, the invoking automatic shutoff would make sense, bypassing human intervention.

Various outputs can be generated by the system in response to a liquid sensing event.
Audio/Visual (AV) alerts can be presented on-site in the form of bells, horns, flashing lights, and the like.
Text message alerts can be sent to specified phones or computers. These text message alerts can include the severity of the liquid sensing event, and other relevant information.
Email message alerts can be sent to specified phones or computers. These text message alerts can include the severity of the liquid sensing event, and other relevant information.
Immediate water shutoff signals can be sent to the system to be used to shut off one or more water valves. This would typically only be used for the more significant liquid sensing events, such as leak, flawed and catastrophe.
Water shutoff signals can be sent to the system to be used to shut off one or more water valves after a specified period of time if there is no response to a text message or an email message.
Automatic dispatch alerts, possibly in the form of text messages and or email messages, can be sent to plumbers, contractors and other trades who might help remedy the situation.

The system may also include other user defined action(s), for example:
Automatic shutoff after “no flow” for 48 hours.
Certain rules for day-time, other rules for off-hours, weekends and holidays.
All actions are user customizable.

Other features:
Continuous battery and power consumption monitoring.
Automatic inherent tamper detection.
Hourly sensor and system health verification.
Automatic recognition of self-test mode, anytime and anywhere with no setup.
Occupancy sensors indicate if, for example, whether is it safe to shutoff water, whether a manual response should be expected, whether local alarms likely to be effective and so on.
Security Sensors alert building managers whenever restricted areas are accessed.
Security sensors with NFC provide unparalleled credential verification through to biometrics.

In brief, the first illustrated embodiment liquid level sensor 100 comprises a main body 120, a common electrical contact 140c, a base-level electrical contact 140b, a first-raised-level electrical contact 141, a second-raised-level electrical contact 142, a third-raised-level electrical contact 143, and electronic circuitry 150.

More specifically, the first illustrated embodiment liquid level sensor 100 comprises a main body 120 that extends between a first end 121 and a second end 122, a top 123, a bottom 124, a first side 125 and a second side 126, and with an upper body portion 120u. The main body 120 also comprises a ground contact portion 127. As illustrated, the ground contact portion 127 is disposed adjacent the first end 121 of the main body 120. As illustrated, the ground contact portion 127 comprises a foot portion 128 disposed at the first end 121 of the main body 120.

The liquid level sensor 100 further comprises a substantially “U”-shaped grasping handle 130 extending outwardly from the main body 120. The grasping handle 130 is disposed adjacent the first end of the main body 120, and more specifically is disposed at the first end of the main body 120 and extends outwardly from the foot portion 128. A securing clip 132 may be placed in surrounding relation around the handle and used to secure the liquid level sensor 100 to a surface such as a floor.

A common electrical contact 140c projects externally to the main body 120, and more specifically extends downwardly from the bottom of the main body 120. Similarly, a base-level electrical contact 140b projects externally to the main body 120, and more specifically extends downwardly from the bottom of the main body 120. The common electrical contact 140c and the base-level electrical contact 140b together define a base liquid sensing level BL. As can be readily seen, the base liquid sensing level BL is at the outer ends 141c,141b, of the common electrical contact 140c and the base-level electrical contact 140b, respectively.

Further, the common electrical contact 140c, the base-level electrical contact 140b, and the ground contact portion 127 of the main body 120 together define a ground contact plane GCPL. The ground contact plane GCPL is at ground level when the liquid level sensor 100 is in place. Accordingly, the base liquid sensing level BL is at the ground contact plane GCPL, or in other words at ground level. Such positioning of the base liquid sensing level BL allows a small amount of moisture on the ground to be sensed, such as from perhaps small-size leaks and the like.

A first-raised-level electrical contact 141 also projects externally to the main body 120. The common electrical contact 140c and the first-raised-level electrical contact 141 together define a first raised liquid sensing level 1SL. The first-raised-level electrical contact 141 is disposed in offset relation from the ground contact plane GCPL by a first offset distance 1OD. In the first illustrated embodiment, the first offset distance 1OD is about 2 (two) centimeters, which can allow for the detection of liquid from perhaps mid-size leaks and the like.

The liquid level sensor 100 further comprises a second-raised-level electrical contact 142 projecting externally to the main body 120. The second-raised-level electrical contact 142 is disposed in offset relation from the ground contact plane GCPL by a second offset distance 2OD. In the first illustrated embodiment, the second offset distance 2OD is about 4 (four) centimeters, which can allow for the detection of liquid from perhaps large-size leaks and the like.

It can also be considered that the first-raised-level electrical contact 141 is disposed in offset relation from a line L extending between the common electrical contact 140c and the base-level electrical contact 140b by a third offset distance 3OD. If both of the base-level electrical contact 140b and the first-raised-level electrical contact 141 are in the ground contact plane GCPL, the third offset distance 3OD would be the same as the first offset distance 1OD. Accordingly, as illustrated, the third offset distance 3OD is about 2 (two) centimeters.

Similarly, the second-raised-level electrical contact 142 is disposed in offset relation from the line L extending between the common electrical contact 140c and the base-level electrical contact 140b by a fourth offset distance 4OD. If both of the base-level electrical contact 140b and the second-raised-level electrical contact 142 are in the ground contact plane GCPL, the fourth offset distance 4OD would be the same as the second offset distance 2OD. Accordingly, as illustrated, the fourth offset distance is about 4 (four) centimeters.

There may also be a third-raised-level electrical contact 143 projecting externally to the main body 120 and disposed in offset relation from the ground contact plane GCPL and from the line “L” extending between the common electrical contact 140c and the base-level electrical contact 140b.

A portion 129 of the bottom 124 of the main body 120 is sloped downwardly from the foot portion 128 to the second end 122 of the main body 120. The common electrical contact 140c, the base-level electrical contact 140b, the first-raised-level electrical contact 141 and the second-raised-level electrical contact 142 are all on the downwardly sloped portion 129 of the bottom 124 of the main body 120.

The first illustrated embodiment liquid level sensor 100 also comprises electronic circuitry 150 responsive to a path between the common electrical contact 140c and the base-level electrical contact 140b being electrically closed by moisture and to generate a base-level alarm signal, and responsive to a path between the common electrical contact 140c and the first-raised-level electrical contact 141 being electrically closed by moisture and to generate a first-level alarm signal, and responsive to a path between the common electrical contact 140c and the second-raised-level electrical contact 142 being electrically closed by moisture and to generate a second-level alarm signal.

A battery 152 and an antenna 154 are included with the electronic circuitry 150. In order to help maximize the effectiveness of the electronic circuitry 150, the battery 152 is located adjacent the bottom 124 of the main body 120 and the antenna 154 is located adjacent the top 123 of the main body 120.

In use, when moisture closes a path between the common electrical contact 140c and the base-level electrical contact 140b, the base-level alarm signal is generated to thereby indicate the base liquid sensing level BL, when moisture closes a path between the common electrical contact 140c and the first-level electrical contact 141, the first-level alarm signal is generated to thereby indicate the first raised liquid sensing level 1SL, and when moisture closes a path between the common electrical contact 140c and the second-raised-level electrical contact 142, the second-level alarm signal is generated, to thereby indicate the second raised liquid sensing level 2SL.

It should be understood that any of the various types of alarm signals that are generated in response to detecting liquid, which may be known as a “liquid sensing event”, may represent any of the base liquid sensing level BL, the first raised liquid sensing level 1SL, the second raised liquid sensing level 2SL, or any other levels as suitably determined.

Reference will now be made to FIG. 4, which shows a second illustrated embodiment of the liquid level sensor 200 according to the present invention. The second illustrated embodiment liquid level sensor 200 is similar to the first illustrated embodiment of the liquid level sensor 100 except that the angle of the foot portion 228 is selectively adjustable with respect to the rest of the main body 220, as indicated by arrows A, to thereby allow the first offset distance 1OD, the second offset distance 2OD, the third offset distance 3OD, and the fourth offset distance 4OD to be selectably adjusted.

A portion 229 of the bottom 224 of the main body 220 is sloped downwardly from the foot portion 228 to the second end 222 of the main body 220. The common electrical contact 240c, the base-level electrical contact 240b, the first-raised-level electrical contact 241 and the second-raised-level electrical contact 242 are all on the downwardly sloped portion 229 of the bottom 224 of the main body 220.

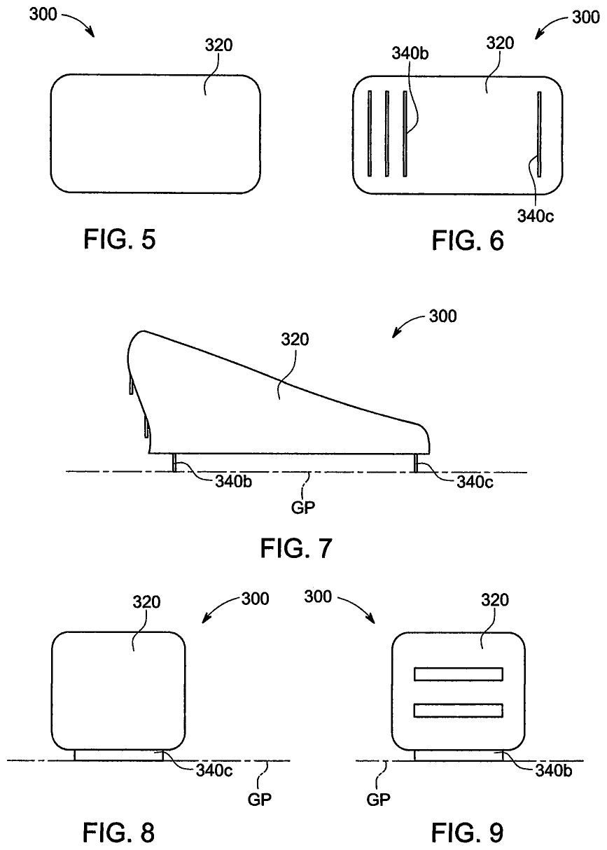

Reference will now be made to FIGS. 5 through 9, which show a third illustrated embodiment of the liquid level sensor 300 according to the present invention. The third illustrated embodiment liquid level sensor 300 is similar to the first illustrated embodiment of the liquid level sensor 100 except that the common electrical contact 340c and the base-level electrical contact 340b together define a ground contact plane GCPL, without the inclusion of a portion of the main body 320.

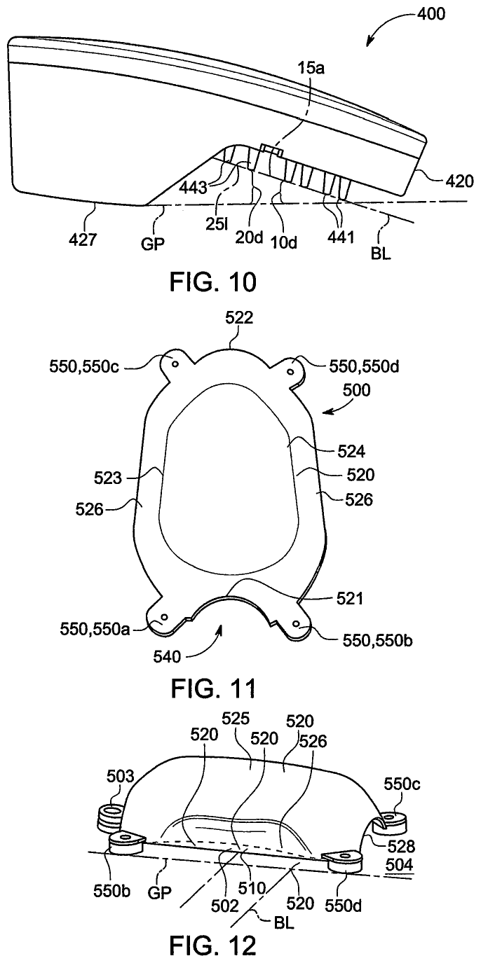

Reference will now be made to FIG. 10, which shows a fourth illustrated embodiment of the liquid level sensor 400 according to the present invention. The fourth illustrated embodiment liquid level sensor 400 is similar to the first illustrated embodiment of the liquid level sensor 100 except that the common electrical contact 140c and the base-level electrical contact 140b are replaced by a first pair of electrical contacts 441 projecting externally to the main body 420. The pair of electrical contacts 441 with each other defines a base liquid sensing level BL.

The fourth illustrated embodiment liquid level sensor 400 further comprises a ground contact portion 427 of the main body 420. The first pair of electrical contacts 441 and the ground contact portion 427 of the main body together define a ground contact plane GCPL.

Further, there is a second pair of electrical contacts 442 projecting externally to the main body 420. The second pair of electrical contacts 442 defines a first raised liquid sensing level 1SL. The second pair of electrical contacts 442 is disposed in offset relation from the ground contact plane GCPL by a first offset distance 1OD. In the fourth illustrated embodiment, the first offset distance 1OD is about 2 (two) centimeters, which can allow for the detection of liquid from perhaps mid-size leaks and the like.

Also, there is a third pair of electrical contacts 443 projecting externally to the main body 420. The third pair of electrical contacts 443 defines a second raised liquid sensing level 2SL. The third pair of electrical contacts 443 is disposed in offset relation from the ground contact plane GCPL by a second offset distance 2OD. In the fourth illustrated embodiment, the second offset distance 2OD is about 4 (four) centimeters, which can allow for the detection of liquid from perhaps large-size leaks and the like.

Reference will now be made to FIGS. 11 and 12, which show an illustrated embodiment of the protective cover according to the present invention, as indicated by the general reference numeral 500. The protective cover 500 is for use with a liquid level sensor 502. The protective cover 500 comprises a thin curved main shell body 520 extending between a first end 521 and a second end 522, between a first side 523 and a second side 524, and between and top portion 525 and a bottom edge 526. The bottom edge 526 of the main shell body 520 defines a space 528 between a portion the bottom edge 526 of the main shell body 520 at each end 521,522 thereof, and a ground contact plane GCPL. The space 528 is for receiving a portion of a liquid level sensor 502 therethrough, specifically the grasping handle 503. The space 528 is disposed adjacent the first end 521 of the main shell body 520.

The main shell body 520 defines an open cavity 540 extending upwardly from the bottom edge 526 and open to the bottom of the main shell body 520.

There is a ground contact portion 550 disposed at the bottom of the main shell body 520 to define the ground contact plane GCPL. The ground contact portion 550 comprises at least one foot, and in the fifth illustrated embodiment, the at least one foot comprises a plurality of feet. More specifically, the plurality of feet comprises four feet 550a, 550b, 550c, and 550d disposed two at each end of the main shell body 520. The bottom edge 526 is raised between adjacent feet 550a, 550b, 550c, and 550d to permit liquid to flow under the main shell body 520 to the liquid level sensor 502.

It will be readily understood that there is a variety of options for attachment of the protective cover 500 to a receiving surface such as a floor. These options include:
1 No secure attachment, just placement
2. Hook-and-Loop fasteners (Velcro™)
3. Threaded fasteners
4. Adhesives
5. Any combination of 2), 3) 4)

In another aspect, the present invention comprises a combination of a liquid level sensor and a protective cover, as indicated by the general reference numeral 600. More specifically, the combination 600 comprises a liquid level sensor 610 and a protective cover 601. The liquid level sensor 610 has a main body 612 with a ground contact portion 613 that defines a ground contact plane GCP. There are electrical contacts 620 projecting externally to the main body 610 and defining a base liquid sensing level BL and a first raised liquid sensing level 1SL. The protective cover 601 comprises a main shell body 640. The upper body portion 611 of the liquid level sensor 610 and the main shell body 640 of the protective cover 601 are similar in shape each to the other. In this manner, the protective cover 601 can have a low profile and a curved shape to make it more difficult for pets to chew on.

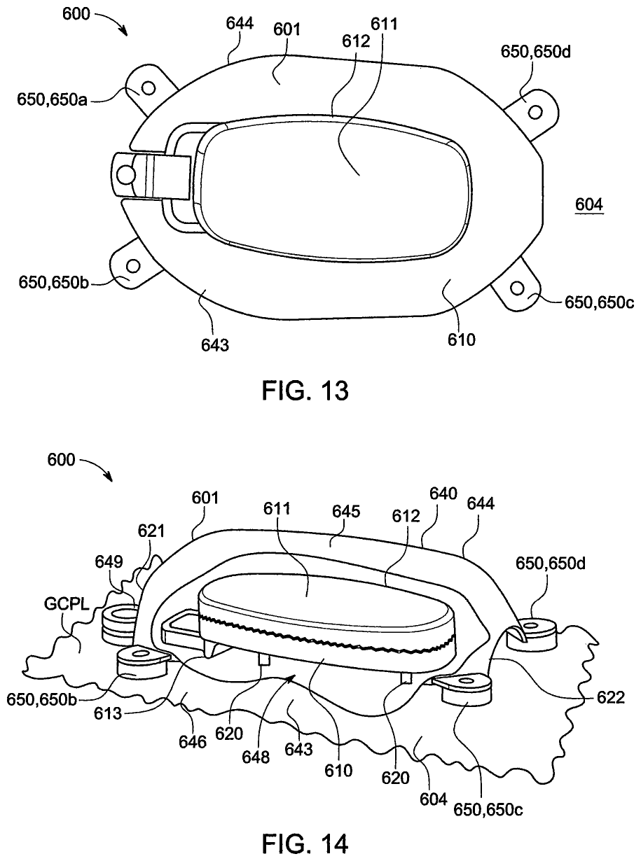

The main shell body 640 extends between a first end 641 and a second end 642, between a first side 643 and a second side 644, and between and top portion 645 and a bottom edge 646, and defines an open cavity 648 extending upwardly from the bottom edge 646 and open to the bottom of the main shell body 640. The open cavity 648 is a sensor-receiving cavity, and in the illustrated embodiment is a sensor-receiving concavity. The main shell body 640 has a ground contact portion 650 is disposed at the bottom of the main shell body 640 to define the ground contact plane GCPL. The ground contact portion 650 of the main shell body 640 defines a larger ground contact area than the ground contact portion 613 of the main body 612 of the liquid level sensor 610. The ground contact portion 650 comprises at least one foot, and in FIGS. 13 and 14, the at least one foot comprises a plurality of feet. More specifically, the plurality of feet comprises four feet 650a, 650b, 650c, and 650d disposed two at each end of the main shell body 620. The bottom edge 646 is raised between adjacent feet 650a, 650b, 650c, and 650d to permit liquid to flow under the main shell body 640 to the liquid level sensor 610.

In use, the liquid level sensor 610 rests on a receiving surface 602 at the ground contact plane GCPL and the main shell body 640 rests on the receiving surface 602 at the ground contact plane GCPL in overlying protective relation to the liquid level sensor 610. Further, the ground contact portion 650 of the main shell body 640 peripherally surrounds the ground contact portion 613 of the main body 612 of the liquid level sensor 610. Also, the main shell body 640 is disposed in overlying relation to the liquid level sensor 610.

The bottom edge 646 of the main shell body 640 is shaped to define a space 649 between the bottom edge 646 of the main shell body 640 and the ground contact plane GCPL. The space 649 is for receiving a portion of a liquid level sensor 610 therethrough, if desired.

In use, the liquid level sensor 610 rests on a receiving surface 604 at the ground contact plane GCPL and the main shell body 640 rests on the receiving surface 604 at the ground contact plane GCPL in overlying protective relation to the liquid level sensor 610.

In the present invention, the following is also contemplated.

One or more electronic reset contacts could be included. The electronic reset contacts could have a different input impedance then the liquid level sensing contacts such that even salty water would not induce a sensor reset. The impedance of reset contacts might be such that shorting the pins with a paperclip, coin or other metallic object would induce a sensor reset.

The electronic system that responds to changes of impedance between the common and a plurality of sensing pins, and an electronic system that is capable of periodically energizing the sensing pins in a way that if a product was immersed in water, and as such would induce a current in all sensing pins, the periodic energizing of the sensing pins would prevent premature battery drain. (I.e., the CPU only energizes the sensing contacts periodically, for example 10 ms per 1000 ms, or 2 ms in every 200 ms, either resulting in a 1 duty cycle. This provides for full functionality while protecting battery life of up to 10 years from a coin cell battery.

The electronic system that capacitively connects the reset contacts to the reset function in order to protect from battery drain. The electronic system that protects the system from accidental reset if the applied impedance to the reset contacts changes slowly (i.e. the reset pulse will only reset the CPU in response to an instantaneous short via paperclip or coin for example).

Other variations are within the spirit of the present invention. Thus, while the invention is susceptible to various modifications and alternative constructions without departing from the spirit of the inventions disclosed and claimed, only a limited number of embodiments or variations thereof have been illustrated or otherwise disclosed herein by way of non-limiting example. It should be understood, however, that there is no intention to limit the invention to the specific form or forms disclosed, but on the contrary, the intention is to cover all modifications, alternative constructions, and equivalents falling within the spirit and scope of the invention, as defined in the appended claims broadly construed.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. The use of any and all examples, or exemplary language (e.g., “such as”, or, “for example”) provided herein, is intended merely to better illuminate embodiments of the invention and does not pose a limitation on the scope of the invention unless otherwise claimed. No language in the specification should be construed as indicating any non-claimed element as essential to the practice of the invention.

Currently preferred embodiments of this invention are described herein. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### APPENDIX

### Gateway and or Cloud Processes

Key system features:
User definable/selectable/customizable response based on severity of leak event
Four (4) graduated leak events are readily possible and useful—moisture, leak, flood and catastrophe
Leak detection can be further qualified by pressure, temperature and flow characteristics
In response to an event:
   Audio visual (AV) alerts on site
   Text message alert—with severity
   E-mail message alert—with severity
   Immediate water shut off
   Water shut-off after timed “No response to text or e-mail”
   Automatic dispatch to plumbers, contractors and other trades
Other user defined action(s), for example, automatic shut-off after “no flow” for 48 hours
Certain rules for day-time, other rules for off-hours, weekends and holidays
All actions are user customizable
   Other features:

Continuous battery and power consumption monitoring
Automatic inherent tamper detection
Hourly sensor and system health verification
Automatic recognition of self-test mode, anytime and anywhere with no set-up
Occupancy sensors indicate if, for example, is it safe to shut off water, should a manual response expected, and local alarms likely to be effective and soon
Security sensors alert building managers whenever restricted areas are accessed
Security sensors with NFC provide unparalleled credential verification through biometrics

1. A liquid level sensor comprising:
A main body;
a common electrical contact;
a base-level electrical contact;
wherein said common electrical contact and said base-level electrical contact together define a base liquid sensing level;
a first-raised-level electrical contact;
wherein said common electrical contact and said first-raised-level electrical contact together define a first raised liquid sensing level; and,
electronic circuitry responsive to a path between said common electrical contact and said base-level electrical contact being electrically closed by moisture and to generate a base-level alarm signal, and responsive to a path between said common electrical contact and said first-raised-level electrical contact being electrically closed by moisture and to generate a second-level alarm signal;
wherein, in use, when moisture closes a path between said common electrical contact and said base-level electrical contact, said base-level alarm signal is generated to thereby indicate said base liquid sensing level, and when moisture closes a path between said common electrical contact and said first-raised-level electrical contact, said second-level alarm signal is generated.

2. A liquid level sensor according to claim 1, further comprising a ground contact portion of said main body, and wherein said common electrical contact, said base-level electrical contact, and said ground contact portion of said main body together define a ground contact plane.

3. A liquid level sensor according to claim 2, wherein said first-raised-level electrical contact is disposed in offset relation from said ground contact plane by a first offset distance.

4. A liquid level sensor according to claim 3, further comprising a second-raised-level electrical contact, and wherein said second-raised-level electrical contact is disposed in offset relation from said ground contact plane by a second offset distance.

5. A liquid level sensor according to claim 2, wherein said main body extends between a first end and a second end, and wherein said ground contact portion is disposed adjacent said first end of said main body.

6. A liquid level sensor according to claim 5, wherein said ground contact portion comprises a foot portion disposed adjacent said first end of said main body.

7. A liquid level sensor according to claim 6, wherein said ground contact portion comprises a foot portion disposed at said first end of said main body.

8. A liquid level sensor according to claim 6, further comprising a grasping handle extending outwardly from said main body.

9. A liquid level sensor according to claim 8, wherein said grasping handle is substantially “U”-shaped, wherein said grasping handle is disposed adjacent said first end of said main body.

10. A liquid level sensor according to claim 9, wherein said grasping handle extends outwardly from said foot portion.

11. A liquid level sensor according to claim 1, wherein said first-raised-level electrical contact is disposed in offset relation from a line extending between said common electrical contact and said base-level electrical contact by a third offset distance.

12. A liquid level sensor according to claim 11, wherein said second-raised-level electrical contact is disposed in offset relation from a line extending between said common electrical contact and said base-level electrical contact by a fourth offset distance.

13. A liquid level sensor according to claim 6, wherein the angle of said foot portion is selectively adjustable with respect to the rest of said main body, to thereby allow said first offset distance and said second first offset distance.

14. A liquid level sensor according to claim 1, wherein said common electrical contact and said base-level electrical contact together define a ground contact plane.

15. A liquid level sensor according to claim 6, wherein a portion of the bottom of said main body is sloped downwardly from said foot portion to said second end of said main body.

16. A liquid level sensor according to claim 15, wherein said common electrical contact, said base-level electrical contact, said first-raised-level electrical contact and said second-raised-level electrical contact are all on said downwardly sloped portion of the bottom of said main body.

17. A liquid level sensor according to claim 1, wherein said a common electrical contact projects externally to said main body, said base-level electrical contact projects externally to said main body, said first-raised-level electrical contact projects externally to said main body, and said second-raised-level electrical contact projects externally to said main body.

18. A liquid level sensor comprising:
a main body;
a first pair of electrical contacts;
wherein said first pair of electrical contacts defines a base liquid sensing level;
a second pair of electrical contacts;
wherein said second pair of electrical contacts defines a first raised liquid sensing level; and,
electronic circuitry responsive to a path between said first pair of electrical contacts being electrically closed by moisture and to generate a base-level alarm signal, and responsive to a path between said second pair of electrical contacts being electrically closed by moisture and to generate a second-level alarm signal;
wherein, in use, when moisture closes a path between said first pair of electrical contacts, said base-level alarm signal is generated to thereby indicate said base liquid sensing level, and when moisture closes a path between said second pair of electrical contacts, said second-level alarm signal is generated.

19. A liquid level sensor according to claim 18, further comprising a ground contact portion of said main body, and wherein said first pair of electrical contacts and said ground contact portion of said main body together define a ground contact plane.

20. A protective cover for use with a liquid level sensor, said protective cover comprising:
a main shell body extending between a first end and a second end, between a first side and a second side, and between and top portion and a bottom edge;
wherein said main shell body defines an open cavity defined by a bottom edge and open to the bottom of said main shell body.
